(19) United States
(12) Patent Application Publication
(10) Pub. No.: US 2026/0181433 A1
(43) Pub. Date: Jun. 25, 2026

(54) TROUBLESHOOTING WIRELESS COMMUNICATION NETWORKS USING FINITE STATE MACHINES

(71) Applicant: AT&T Intellectual Property I, L.P., Atlanta, GA (US)

(72) Inventors: Amit Kumar Sheoran, Raritan, NJ (US); Abdullah Al Ishtiaq, State College, PA (US); Jia Wang, Bedminster, NJ (US); Xiaofeng Shi, Vernon, CT (US)

(21) Appl. No.: 18/991,683

(22) Filed: Dec. 22, 2024

(51) Int. Cl. H04W 24/08; G06F 9/448

(52) U.S. Cl. CPC H04W 24/08; G06F 9/4498

(57) ABSTRACT

A method includes detecting an outage in a wireless communications network, acquiring specifications documents describing communication protocols between a plurality of network elements and a plurality of user equipment of the network, translating, using a generative artificial intelligence technique, the specifications documents into a first FSM that models expected events and corresponding actions from perspectives of the plurality of network elements and the plurality of user equipment, translating, using the generative artificial intelligence technique, a plurality of event logs of the network into a second FSM that models observed behaviors of the plurality of network elements and the plurality of user equipment, detecting, based on a comparison of the second FSM to the first FSM, a behavior of the observed behaviors that deviates from the communication protocols, and identifying a network element of the plurality of network elements that is associated with the behavior as a contributor to the outage.

The present disclosure relates generally to communications networks and relates more particularly to devices, non-transitory computer-readable media, and methods for troubleshooting wireless communication networks using finite state machines.

### BACKGROUND

Wireless networks, including cellular networks, are carefully provisioned and deployed to ensure that network resources are available to end users. This helps to ensure efficient communication, resource optimization, and adaptability to changing demands.

### SUMMARY

In one example, the present disclosure describes a device, computer-readable medium, and method carefully for troubleshooting wireless communication networks using finite state machines. For instance, in one example, a method performed by a processing system including at least one processor includes detecting an outage in a wireless communications network, acquiring a plurality of specifications documents describing communication protocols between a plurality of network elements and a plurality of user equipment of the wireless communications network, translating, using a generative artificial intelligence technique, the plurality of specifications documents into a first finite state machine that models expected events and corresponding actions from perspectives of the plurality of network elements and the plurality of user equipment, translating, using the generative artificial intelligence technique, a plurality of event logs of the wireless communications network into a second finite state machine that models observed behaviors of the plurality of network elements and the plurality of user equipment, detecting, based on a comparison of the second finite state machine to the first finite state machine, a behavior of the observed behaviors that deviates from the communication protocols, and identifying a network element of the plurality of network elements that is associated with the behavior as a contributor to the outage

In another example, a non-transitory computer-readable medium stores instructions which, when executed by a processor, cause the processor to perform operations. The operations include detecting an outage in a wireless communications network, acquiring a plurality of specifications documents describing communication protocols between a plurality of network elements and a plurality of user equipment of the wireless communications network, translating, using a generative artificial intelligence technique, the plurality of specifications documents into a first finite state machine that models expected events and corresponding actions from perspectives of the plurality of network elements and the plurality of user equipment, translating, using the generative artificial intelligence technique, a plurality of event logs of the wireless communications network into a second finite state machine that models observed behaviors of the plurality of network elements and the plurality of user equipment, detecting, based on a comparison of the second finite state machine to the first finite state machine, a behavior of the observed behaviors that deviates from the communication protocols, and identifying a network element of the plurality of network elements that is associated with the behavior as a contributor to the outage.

In another example, a device includes a processor and a computer-readable medium storing instructions which, when executed by the processor, cause the processor to perform operations. The operations include detecting an outage in a wireless communications network, acquiring a plurality of specifications documents describing communication protocols between a plurality of network elements and a plurality of user equipment of the wireless communications network translating, using a generative artificial intelligence technique, the plurality of specifications documents into a first finite state machine that models expected events and corresponding actions from perspectives of the plurality of network elements and the plurality of user equipment, translating, using the generative artificial intelligence technique, a plurality of event logs of the wireless communications network into a second finite state machine that models observed behaviors of the plurality of network elements and the plurality of user equipment, detecting, based on a comparison of the second finite state machine to the first finite state machine, a behavior of the observed behaviors that deviates from the communication protocols, and identifying a network element of the plurality of network elements that is associated with the behavior as a contributor to the outage

### BRIEF DESCRIPTION OF THE DRAWINGS

The teachings of the present disclosure can be readily understood by considering the following detailed description in conjunction with the accompanying drawings, in which:

FIG. 1 illustrates an example network, or system, in which examples of the present disclosure may operate;

FIG. 2 illustrates a flowchart of an example method for troubleshooting wireless communication networks using finite state machines, in accordance with the present disclosure;

FIG. 3 illustrates a flowchart of an example method for verifying new network components using finite state machines, in accordance with the present disclosure;

FIG. 4 illustrates a flowchart of an example method for troubleshooting user equipment deployed in wireless communication networks using finite state machines, in accordance with the present disclosure;

FIG. 5 illustrates a flowchart of an example method for updating specifications documents for wireless communication networks using finite state machines, in accordance with the present disclosure; and

FIG. 6 depicts a high-level block diagram of a computing device specifically programmed to perform the functions described herein.

To facilitate understanding, identical reference numerals have been used, where possible, to designate identical elements that are common to the figures.

### DETAILED DESCRIPTION

In one example, the present disclosure troubleshoots wireless communication networks using finite state machines. As discussed above, wireless networks, including cellular networks, are carefully provisioned and deployed to ensure that network resources are available to end users. This helps to ensure efficient communication, resource optimization, and adaptability to changing demands.

Despite sophisticated design and careful deployment, however, wireless communication networks occasionally experience connectivity issues or outages due to various causes (e.g., network overload, device misconfigurations, equipment failure, and the like). Additionally, end users may experience loss of connectivity due to misconfigurations of their user equipment (UEs), software errors, or provisioning mistakes. To mitigate customer dissatisfaction and financial loss, an operator of a wireless network that is experiencing connectivity issues needs to be able to swiftly identify the root cause of the issues and implement appropriate measures to correct the issues. However, the potential root causes of connectivity issues are varied, and determining the root cause of a specific connectivity issue may be challenging due to the myriad of different equipment and software provided by several different vendors.

Current troubleshooting often relies on manual analysis of network events. For instance, individual end users who experience isolated connectivity issues may engage customer care representatives who will typically try to resolve the connectivity issues by manually inspecting network events, traces, and configurations for the entire service function chain (SFC). For larger-scale outages that affect multiple end users, maintenance personnel may be deployed to inspect event logs to identify failing equipment and/or software. Subsequently, vendor-specific guidelines and manuals may be consulted for the appropriate corrective actions.

Examples of the present disclosure automate troubleshooting for wireless communications networks by using finite state machines. In one example, generative artificial intelligence (GenAI) techniques may be used to translate network specifications documents from natural language into a first finite state machine that models the expected behaviors of the network elements and user equipment in a wireless communications network. The same or different GenAI techniques may also be used to translate network event logs into a second finite state machine that models the observed behaviors of the network elements and user equipment in the wireless communications network. Instances where the second finite state machine deviates from the first finite state machine may be indicative of root causes of outages or other connectivity issues in the wireless communications system.

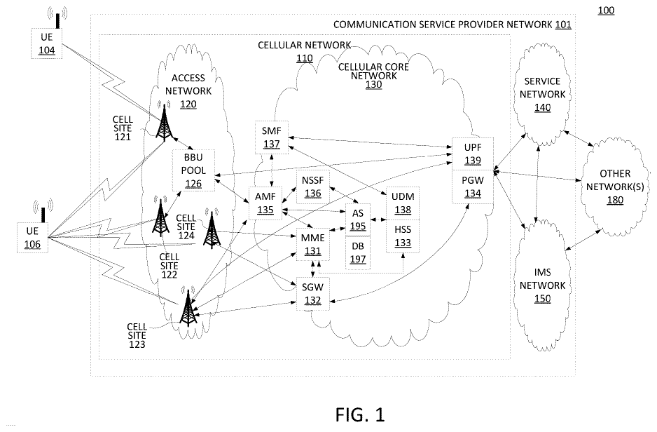

In other examples, similar techniques may be applied to verify correct configuration and functioning of new network elements that have been deployed in the wireless communications network (e.g., where deviations of the second finite state machine from the first finite state machine may indicate incorrect configuration or functioning), to troubleshoot user equipment (e.g., where deviations of the second finite state machine from the first finite state machine may indicate the root cause of a malfunctioning UE), or to update specifications documents and standards to account for previously overlooked information (e.g., where deviations of the second finite state machine may not be indicative of a problem, but simply of a behavior of a network element or UE that is unknown from the specifications for the network element or UE). Unknown behavior in this context may also include cases where the specifications for the network element or UE did not consider the behavior (e.g., incomplete specifications). These and other aspects of the present disclosure are discussed in greater detail in connection with FIGS. 1-6, below.

FIG. 1 illustrates an example network, or system, 100 in which examples of the present disclosure may operate. In one example, the system 100 includes a communication service provider network 101. The communication service provider network 101 may comprise a cellular network 110 (e.g., a 5G network, a 4G/Long Term Evolution (LTE)/5G hybrid network, or the like), a service network 140, and an IP Multimedia Subsystem (IMS) network 150. The system 100 may further include other networks 180 connected to the communication service provider network 101.

In one example, the cellular network 110 comprises an access network 120 and a cellular core network 130. In one example, the access network 120 comprises a radio access network (RAN), such as a cloud RAN, a distributed RAN (D-RAN), a centralized RAN (C-RAN), a virtualized RAN (V-RAN), or an open RAN (O-RAN). For instance, a cloud RAN is part of the 3GPP 5G specifications for mobile networks. As part of the migration of cellular networks towards 5G, a cloud RAN may be coupled to an Evolved Packet Core (EPC) network until new cellular core networks are deployed in accordance with 5G specifications. In one example, access network 120 may include cell sites 121 and 122 and a baseband unit (BBU) pool 126. In a cloud RAN, radio frequency (RF) components, referred to as remote radio heads (RRHs) or radio units (RUs), may be deployed remotely from baseband units, e.g., atop cell site masts, buildings, and so forth. In one example, the BBU pool 126 may be located at distances as far as 20-80 kilometers or more away from the antennas/remote radio heads of cell sites 121 and 122 that are serviced by the BBU pool 126. It should also be noted in accordance with efforts to migrate to 5G networks, cell sites may be deployed with new antenna and radio infrastructures such as MIMO antennas, and millimeter wave antennas.

Although cloud RAN infrastructure may include distributed RRHs and centralized baseband units, a heterogeneous network may include cell sites where RRH and BBU components remain co-located at the cell site. For instance, cell site 123 may include RRH and BBU components. Thus, cell site 123 may comprise a self-contained “base station.” With regard to cell sites 121 and 122, the “base stations” may comprise RRHs at cell sites 121 and 122 coupled with respective baseband units of BBU pool 126. In one example, baseband unit functionality may be split into a centralized unit (CU) and a distributed unit (DU). In addition, the CU and the DU may be physically separate from one another. For instance, a DU may be situated with an RU/RRH at a cell site, while a CU may be in a centralized location hosting multiple CUs. Alternatively, or in addition, a single CU may serve multiple DUs and/or RUs/RRHs. In accordance with the present disclosure a “base station” may therefore comprise at least a BBU (e.g., in one example, a CU and/or a DU), and may further include at least one RRH/RU.

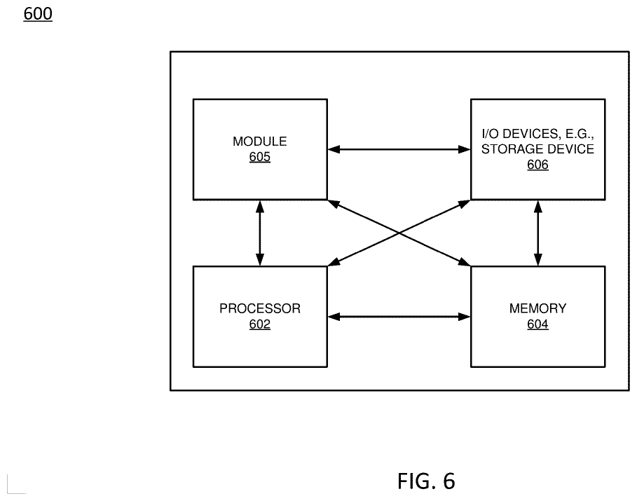

In accordance with the present disclosure, any one or more of cell sites 121-123 may be deployed with antenna and radio infrastructures, including MIMO and millimeter wave antennas. Furthermore, in accordance with the present disclosure, a base station (e.g., cell sites 121-124 and/or baseband units within BBU pool 126) may comprise all or a portion of a computing system, such as computing system 600 as depicted in FIG. 6, and may be configured to perform steps, functions, and/or operations in connection with examples of the present disclosure for troubleshooting wireless communication networks using finite state machines.

In one example, access network 120 may include both 4G/LTE and 5G/NR radio access network infrastructure. For example, access network 120 may include cell site 124, which may comprise 4G/LTE base station equipment, e.g., an eNodeB. In addition, access network 120 may include cell sites comprising both 4G and 5G base station equipment, e.g., respective antennas, feed networks, baseband equipment, and so forth. For instance, cell site 123 may include both 4G and 5G base station equipment and corresponding connections to 4G and 5G components in cellular core network 130. Although access network 120 is illustrated as including both 4G and 5G components, in another example, 4G and 5G components may be considered to be contained within different access networks. Nevertheless, such different access networks may have a same wireless coverage area, or fully or partially overlapping coverage areas.

In one example, the cellular core network 130 provides various functions that support wireless services in the LTE environment. In one example, cellular core network 130 is an Internet Protocol (IP) packet core network that supports both real-time and non-real-time service delivery across an LTE network, e.g., as specified by the 3GPP standards. In one example, cell sites 121 and 122 in the access network 120 are in communication with the cellular core network 130 via baseband units in BBU pool 126.

In cellular core network 130, network nodes such as Mobility Management Entity (MME) 131 and Serving Gateway (SGW) 132 support various functions as part of the cellular network 110. For example, MME 131 is the control node for LTE access network components, e.g., eNodeB aspects of cell sites 121-123. In one embodiment, MME 131 is responsible for UE (User Equipment) tracking and paging (e.g., such as retransmissions), bearer activation and deactivation process, selection of the SGW, and authentication of a user. In one embodiment, SGW 132 routes and forwards user data packets, while also acting as the mobility anchor for the user plane during inter-cell handovers and as an anchor for mobility between 5G, LTE and other wireless technologies, such as 2G and 3G wireless networks.

In addition, cellular core network 130 may comprise a Home Subscriber Server (HSS) 133 that contains subscription-related information (e.g., subscriber profiles), performs authentication and authorization of a wireless service user, and provides information about the subscriber's location. The cellular core network 130 may also comprise a packet data network (PDN) gateway (PGW) 134 which serves as a gateway that provides access between the cellular core network 130 and various packet data networks (PDNs), e.g., service network 140, IMS network 150, other network(s) 180, and the like.

The foregoing describes long term evolution (LTE) cellular core network components (e.g., EPC components). In accordance with the present disclosure, cellular core network 130 may further include other types of wireless network components e.g., 5G network components, 3G network components, etc. Thus, cellular core network 130 may comprise an integrated network, e.g., including any two or more of 2G-5G infrastructures and technologies (or any future infrastructures and technologies to be deployed, e.g., 6G), and the like. For example, as illustrated in FIG. 1, cellular core network 130 further comprises 5G components, including: an access and mobility management function (AMF) 135, a network slice selection function (NSSF) 136, a session management function (SMF) 137, a unified data management function (UDM) 138, and a user plane function (UPF) 139.

In one example, AMF 135 may perform registration management, connection management, endpoint device reachability management, mobility management, access authentication and authorization, security anchoring, security context management, coordination with non-5G components, e.g., MME 131, and so forth. NSSF 136 may select a network slice or network slices to serve an endpoint device, or may indicate one or more network slices that are permitted to be selected to serve an endpoint device. For instance, in one example, AMF 135 may query NSSF 136 for one or more network slices in response to a request from an endpoint device to establish a session to communicate with a PDN. The NSSF 136 may provide the selection to AMF 135, or may provide one or more permitted network slices to AMF 135, where AMF 135 may select the network slice from among the choices. A network slice may comprise a set of cellular network components, such as AMF(s), SMF(s), UPF(s), and so forth that may be arranged into different network slices which may logically be considered to be separate cellular networks. In one example, different network slices may be preferentially utilized for different types of services. For instance, a first network slice may be utilized for sensor data communications, Internet of Things (IoT), and machine-type communication (MTC), a second network slice may be used for streaming video services, a third network slice may be utilized for voice calling, a fourth network slice may be used for gaming services, and so forth.

In one example, SMF 137 may perform endpoint device IP address management, UPF selection, UPF configuration for endpoint device traffic routing to an external packet data network (PDN), charging data collection, quality of service (QoS) enforcement, and so forth. UDM 138 may perform user identification, credential processing, access authorization, registration management, mobility management, subscription management, and so forth. As illustrated in FIG. 1, UDM 138 may be tightly coupled to HSS 133. For instance, UDM 138 and HSS 133 may be co-located on a single host device, or may share a same processing system comprising one or more host devices. In one example, UDM 138 and HSS 133 may comprise interfaces for accessing the same or substantially similar information stored in a database on a same shared device or one or more different devices, such as subscription information, endpoint device capability information, endpoint device location information, and so forth. For instance, in one example, UDM 138 and HSS 133 may both access subscription information or the like that is stored in a unified data repository (UDR) (not shown).

UPF 139 may provide an interconnection point to one or more external packet data networks (PDN(s)) and perform packet routing and forwarding, QoS enforcement, traffic shaping, packet inspection, and so forth. In one example, UPF 139 may also comprise a mobility anchor point for 4G-to-5G and 5G-to-4G session transfers. In this regard, it should be noted that UPF 139 and PGW 134 may provide the same or substantially similar functions, and in one example, may comprise the same device, or may share a same processing system comprising one or more host devices.

It should be noted that other examples may comprise a cellular network with a “non-stand alone” (NSA) mode architecture where 5G radio access network components, such as a “new radio” (NR), “gNodeB” (or “gNB”), and so forth are supported by a 4G/LTE core network (e.g., an EPC network), or a 5G “standalone” (SA) mode point-to-point or service-based architecture where components and functions of an EPC network are replaced by a 5G core network (e.g., a “5GC”). For instance, in non-standalone (NSA) mode architecture, LTE radio equipment may continue to be used for cell signaling and management communications, while user data may rely upon a 5G new radio (NR), including millimeter wave communications, for example. However, examples of the present disclosure may also relate to a hybrid, or integrated 4G/LTE-5G cellular core network such as cellular core network 130 illustrated in FIG. 1. In this regard, FIG. 1 illustrates a connection between AMF 135 and MME 131, e.g., an “N26” interface which may convey signaling between AMF 135 and MME 131 relating to endpoint device tracking as endpoint devices are served via 4G or 5G components, respectively, signaling relating to handovers between 4G and 5G components, and so forth.

In one example, service network 140 may comprise one or more devices for providing services to subscribers, customers, and/or users. For example, communication service provider network 101 may provide a cloud storage service, web server hosting, and other services. As such, service network 140 may represent aspects of communication service provider network 101 where infrastructure for supporting such services may be deployed. In one example, other networks 180 may represent one or more enterprise networks, a circuit switched network (e.g., a public switched telephone network (PSTN)), a cable network, a digital subscriber line (DSL) network, a metropolitan area network (MAN), an Internet service provider (ISP) network, and the like. In one example, the other networks 180 may include different types of networks. In another example, the other networks 180 may be the same type of network. In one example, the other networks 180 may represent the Internet in general. In this regard, it should be noted that any one or more of service network 140, other networks 180, or IMS network 150 may comprise a packet data network (PDN) to which an endpoint device may establish a connection via cellular core network 130 in accordance with the present disclosure.

In one example, any one or more of the components of cellular core network 130 may comprise network function virtualization infrastructure (NFVI), e.g., SDN host devices (i.e., physical devices) configured to operate as various virtual network functions (VNFs), such as a virtual MME (vMME), a virtual HHS (vHSS), a virtual serving gateway (vSGW), a virtual packet data network gateway (vPGW), and so forth. For instance, MME 131 may comprise a vMME, SGW 132 may comprise a vSGW, and so forth. Similarly, AMF 135, NSSF 136, SMF 137, UDM 138, and/or UPF 139 may also comprise NFVI configured to operate as VNFs. In addition, when comprised of various NFVI, the cellular core network 130 may be expanded (or contracted) to include more or less components than the state of cellular core network 130 that is illustrated in FIG. 1. It should be noted that intermediate devices and links between MME 131, SGW 132, cell sites 121-124, PGW 134, AMF 135, NSSF 136, SMF 137, UDM 138, and/or UPF 139, and other components of system 100 are also omitted for clarity, such as additional routers, switches, gateways, and the like.

FIG. 1 also illustrates various endpoint devices, e.g., user equipment (UE) 104 and 106. Each of the UEs 104 and 106 may comprise a cellular telephone, a smartphone, a tablet computing device, a laptop computer, a pair of computing glasses, a wireless enabled wristwatch, a wireless transceiver for a fixed wireless broadband (FWB) deployment, an item of customer premises equipment, or any other cellular-capable mobile telephony and computing device (broadly, “an endpoint device”). For instance, each of the UEs 104 and 106 may include one or more radio frequency (RF) transceivers for cellular communications and/or for non-cellular wireless communications. In one example, each of the UEs 104 and 106 may be equipped with one or more directional antennas, or antenna arrays (e.g., having a half-power azimuthal beamwidth of 120 degrees or less, 90 degrees or less, 60 degrees or less, etc.), e.g., MIMO antenna(s) to receive and/or to transmit multi-path and/or spatial diversity signals.

In one example, each of the UEs 104 and 106 may comprise all or a portion of a computing system, such as computing system 600 depicted in FIG. 6, and may be configured to perform steps, functions, and/or operations in connection with examples of the present disclosure for troubleshooting wireless communication networks using finite state machines. In this regard, it should be noted that as used herein, the terms “configure,” and “reconfigure” may refer to programming or loading a processing system with computer-readable/computer-executable instructions, code, and/or programs, e.g., in a distributed or non-distributed memory, which when executed by a processor, or processors, of the processing system within a same device or within distributed devices, may cause the processing system to perform various functions. Such terms may also encompass providing variables, data values, tables, objects, or other data structures or the like which may cause a processing system executing computer-readable instructions, code, and/or programs to function differently depending upon the values of the variables or other data structures that are provided. As referred to herein a “processing system” may comprise a computing device including one or more processors, or cores (e.g., as illustrated in FIG. 6 and discussed below) or multiple computing devices collectively configured to perform various steps, functions, and/or operations in accordance with the present disclosure.

As illustrated in FIG. 1, UE 104 may access wireless services via the cell site 121 (e.g., NR alone, where cell site 121 comprises a gNB), while UE 106 may access wireless services via any of the cell sites 121-124 located in the access network 120 (e.g., for NR non-dual connectivity, for LTE non-dual connectivity, for NR-NR DC, for LTE-LTE DC, for EN-DC, and/or for NE-DC). For instance, in one example, UE 106 may establish and maintain connections to the cellular core network 130 via one or multiple gNBs (e.g., cell sites 121 and 122 and/or cell sites 121 and 122 in conjunction with BBU pool 126 and/or various other components, such as a CU and/or a DU). In another example, UE 106 may establish and maintain connections to the cellular core network 130 via a gNB (e.g., cell site 122 and/or cell site 122 in conjunction with BBU pool 126) and an eNodeB (e.g., cell site 124), respectively. In addition, either the gNB or the eNodeB may comprise a PCell, and the other may comprise a SCell for carrier aggregation and/or dual connectivity. Similarly, UE 106 may communicate with any of the cell sites 121 and 122 using carrier aggregation (CA) (e.g., in accordance with a CA technique). Furthermore, either or both of NR/5G and or EPC (4G/LTE) core network components may manage the communications between UE 106 and the cellular network 110 via cell site 122 and cell site 124.

In one example, the cellular core network 130 may further include an application server (AS) 195, which may comprise a computing system or server, such as computing system 600 depicted in FIG. 6, and may be configured to provide one or more operations or functions in connection with examples of the present disclosure for troubleshooting wireless communication networks using finite state machines. The cellular core network 130 may also include a database (DB) 197 that is communicatively coupled to the AS 195.

The AS 195 may comprise one or more physical devices, e.g., one or more computing systems or servers, such as computing system 600 depicted in FIG. 6, and may be configured as described below. It should be noted that as used herein, the terms “configure,” and “reconfigure” may refer to programming or loading a processing system with computer-readable/computer-executable instructions, code, and/or programs, e.g., in a distributed or non-distributed memory, which when executed by a processor, or processors, of the processing system within a same device or within distributed devices, may cause the processing system to perform various functions. Such terms may also encompass providing variables, data values, tables, objects, or other data structures or the like which may cause a processing system executing computer-readable instructions, code, and/or programs to function differently depending upon the values of the variables or other data structures that are provided. As referred to herein a “processing system” may comprise a computing device including one or more processors, or cores (e.g., as illustrated in FIG. 6 and discussed below) or multiple computing devices collectively configured to perform various steps, functions, and/or operations in accordance with the present disclosure.

In one example, the AS 195 may be configured to troubleshoot wireless communication networks using finite state machines. For instance, in some examples, the AS 195 may translate specifications documents describing communication protocols between a plurality of network elements and a plurality of user equipment of the system 100 into a first finite state machine. The AS 195 may also translate event logs for the system 100 into a second finite state machine. Thus, broadly, the first finite state machine may describe expected behaviors of the plurality of network elements and plurality of UEs, while the second finite state machine may describe observed behaviors of the plurality of network elements and plurality of UEs.

Based on a comparison of the first finite state machine to the second finite state machine, the AS 195 may detect instances where the second finite state machine deviates from the first finite state machine. These deviations may be analyzed to determine whether the deviations represent a root cause of a network outage, a misconfiguration of a new network element, a malfunction of a UE, or a behavior of a network element or UE that was overlooked, unknown, or not addressed in the specifications documents.

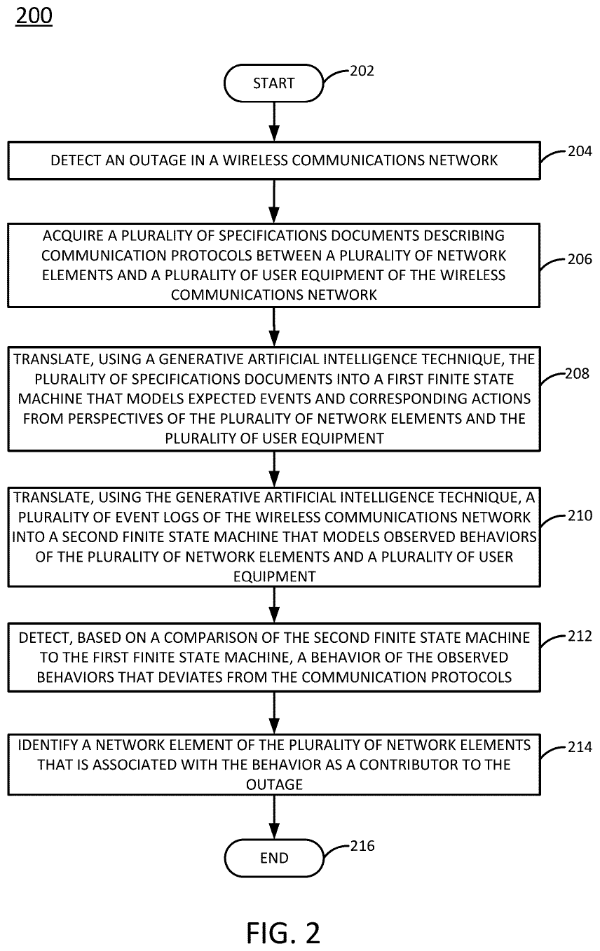

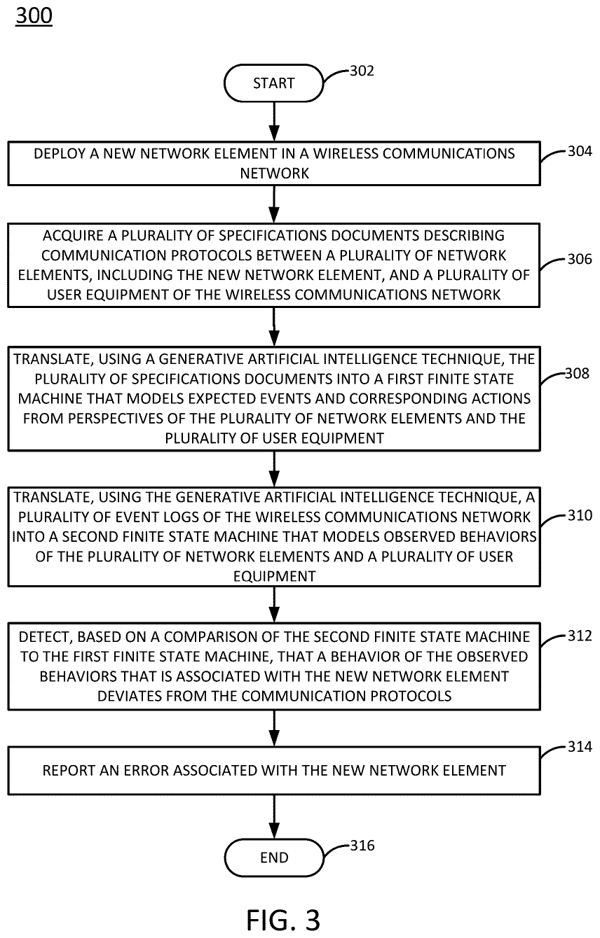

The DB 197 may store the specifications documents, the event logs, and/or the finite state machines. In one example, the DB 197 may comprise a physical storage device integrated with the AS 195 (e.g., a database server or a file server), or attached or coupled to the AS 195, in accordance with the present disclosure. In one example, the AS 195 may load instructions into a memory, or one or more distributed memory units, and execute the instructions for troubleshooting wireless communication networks using finite state machines, as described herein. An example method for troubleshooting wireless communication networks using finite state machines is described in greater detail below in connection with FIG. 2. Methods that use similar approaches to detect misconfigurations of new network elements, malfunctioning UEs, or gaps in the specifications documents are also described in greater detail below in connection with FIGS. 3-5.

In one example, the cellular core network 130 may include multiple instances of the AS 195 and DB 197 distributed throughout the cellular core network 130, where the multiple instances each store identical data for the purposes of redundancy.

The foregoing description of the system 100 is provided as an illustrative example only. In other words, the example of system 100 is merely illustrative of one network configuration that is suitable for implementing examples of the present disclosure. As such, other logical and/or physical arrangements for the system 100 may be implemented in accordance with the present disclosure. For example, the system 100 may be expanded to include additional networks, such as network operations center (NOC) networks, additional access networks, and so forth. The system 100 may also be expanded to include additional network elements such as border elements, routers, switches, policy servers, security devices, gateways, a content distribution network (CDN) and the like, without altering the scope of the present disclosure. In addition, system 100 may be altered to omit various elements, substitute elements for devices that perform the same or similar functions, combine elements that are illustrated as separate devices, and/or implement network elements as functions that are spread across several devices that operate collectively as the respective network elements.

For instance, in one example, the cellular core network 130 may further include a Diameter routing agent (DRA) which may be engaged in the proper routing of messages between other elements within cellular core network 130, and with other components of the system 100, such as a call session control function (CSCF) (not shown) in IMS network 150. In another example, the NSSF 136 may be integrated within the AMF 135. In addition, cellular core network 130 may also include additional 5G NG core components, such as: a policy control function (PCF), an authentication server function (AUSF), a network repository function (NRF), and other application functions (AFs). In one example, any one or more of the cell sites 121-124 may comprise 2G, 3G, 4G and/or LTE radios, e.g., in addition to 5G new radio (NR), or gNB functionality, or any future cellular technology, e.g., 6G and so on. For instance, cell site 123 is illustrated as being in communication with AMF 135 in addition to MME 131 and SGW 132. Thus, these and other modifications are all contemplated within the scope of the present disclosure.

To further aid in understanding the present disclosure, FIG. 2 illustrates a flowchart of an example method 200 for troubleshooting wireless communication networks using finite state machines, in accordance with the present disclosure. In one example, the method 200 may be performed by an application server that is capable of executing a GenAI technique, such as the AS 195 illustrated in FIG. 1. However, in other examples, the method 200 may be performed by another device, such as a 5G network data analytics function (NWDAF) or the processor 602 of the system 600 illustrated in FIG. 6 (where the system 600 may be part of an AS or an NWDAF). For the sake of example, the method 200 is described as being performed by a processing system.

The method 200 begins in step 202. In step 204, the processing system may detect an outage in a wireless communications network.

There are many ways in which the outage may be detected. For instance, in one example, the outage may be detected based on a change in monitored performance metrics of the wireless communications network. For instance, if a decrease in throughput of greater than a threshold decrease is observed within a defined period of time (e.g., a twenty percent decrease in a span of two minutes), this may indicate that an outage in the wireless communications network is likely. Alternatively, the outage may be detected based on the receipt of a threshold number of reports from users of the wireless communications network that are physically located within a defined geographic area (e.g., within the serving area of the same cellular base station). In another example, the outage may be detected based on a failure of network equipment to respond within a threshold period of time (e.g., a router failing to respond to pings for at least five minutes).

In step 206, the processing system may acquire a plurality of specifications documents describing communication protocols between a plurality of network elements and a plurality of user equipment of the wireless communications network. In one example, the plurality of specifications documents may include documents provided by standards bodies (e.g., 3^{rd} Generation Partnership Project, Internet Engineering Task Force, Global System for Mobile Communications Association, and/or the like) and/or documents provided by vendors of the plurality of network elements and/or plurality of UEs. Each of the specifications documents may be written in natural language and may comprise as many as thousands of pages of information about cellular (or other wireless) protocols, including information about expected events (e.g., messages, timeouts of timers, etc.) and corresponding actions from the perspectives of the plurality of network elements and the plurality of user equipment.

In step 208, the processing system may translate, using a generative artificial intelligence technique, the plurality of specifications documents into a first finite state machine that models expected events and corresponding actions from perspectives of the plurality of network elements and the plurality of user equipment.

In one example, the GenAI technique may take as input the plurality of specifications documents written in natural language and may generate as an output the first finite state machine. For instance, in one example, the GenAI technique may utilize an open-source natural language processing (NLP) model to automatically identify the expected events and corresponding actions in the plurality of standards documents.

The GenAI technique may then connect the expected events and corresponding actions extracted from different parts of the plurality of specifications documents. Connecting the expected events and corresponding actions may include merging events or actions that are redundant to produce a single node in a connected graph (where the connected graph comprises the first finite state machine). In one example, the GenAI technique may utilize a generative pretrained transformer (GPT) model.

It should be noted that in some cases, steps 206-208 may be performed before step 204. In other words, the specifications documents can be acquired and translated into the first finite state machine prior to an outage being detected. In this case, the first finite state machine may be stored and retrieved from memory when an outage is detected. This may reduce computational overhead relative to running the GenAI technique each time an outage is detected.

In step 210, the processing system may translate, using the generative artificial intelligence technique, a plurality of event logs of the wireless communications network into a second finite state machine that models observed behaviors of the plurality of network elements and the plurality of user equipment.

In one example, prior to translating the plurality of event logs, the processing system may pre-process the event logs to facilitate construction of the second finite state machine. Pre-processing may involve extracting information from the event logs that dictates the behavior of the plurality of network elements and the plurality of user equipment. Automata learning algorithms may then be used to extract the second finite state machine from the pre-processed event logs.

The second finite state machine may thus represent how the plurality of network elements and the plurality of user equipment are actually interacting in the wireless communications network, as opposed to how the plurality of network elements and the plurality of user equipment are expected to be interacting based on the specifications documents.

In step 212, the processing system may detect, based on a comparison of the second finite state machine to the first finite state machine, a behavior of the observed behaviors that deviates from the communication protocols. In one example, a deviation of the second finite state machine from the first finite state machine may indicate that at least one network element of the plurality of network elements is behaving in a manner that is not expected. This unexpected behavior may comprise a malfunction of at least one network element or a use of the at least one network element that exceeds its capabilities.

In one example, the comparison of the second finite state machine to the first finite state machine may involve converting events from the second finite state machine into natural language conditions/actions, mapping the natural language conditions/actions to corresponding nodes in the first finite state machine (e.g., using a GenAI technique), checking, after the mapping, if a path from one event to a next event exists (e.g., a path from one mapped node to the next mapped node in the first finite state machine), and detecting the behavior based on whether the path exists. In one example, if the path does not exist, then a deviation (e.g., unexpected behavior) is inferred. This is done because the network logs have higher abstractions than the specifications (e.g., a whole procedure containing multiple steps may be represented as a single event in a network log).

In step 214, the processing system may identify a network element of the plurality of network elements that is associated with the behavior as a contributor to the outage. As discussed above, a network element that is observed to be behaving in an unexpected manner, based on the comparison of the first finite state machine to the second finite state machine, may be assumed to be malfunctioning or to be used in a manner that exceeds the network element's capacity. This malfunction or overuse, in turn, may be assumed to be a contributing factor to (if not the root cause of) the outage.

It should be noted that a network element may be specification compliant (e.g., provisioned according to the specifications documents), and may still experience or contribute to an outage. For instance, a properly provisioned gNodeB may become overloaded by serving too many UEs, or an MME may crash due to an implementation bug.

In one example, identifying the network element may involve identifying the network element to an administrator of the wireless communications network (e.g., by sending an alert to the administrator indicating a potential malfunction of the network element). In a further example, the processing system may collect event logs corresponding specifically to the network element for further analysis by the administrator and/or an automated troubleshooting system. The method 200 may end in step 216.

FIG. 3 illustrates a flowchart of an example method 300 for verifying new network components using finite state machines, in accordance with the present disclosure. In one example, the method 300 may be performed by an application server that is capable of executing a GenAI technique, such as the AS 195 illustrated in FIG. 1. However, in other examples, the method 300 may be performed by another device, such as the processor 602 of the system 600 illustrated in FIG. 6. For the sake of example, the method 300 is described as being performed by a processing system.

The method 300 begins in step 302. In step 304, the processing system may deploy a new network element in a wireless communications network. In one example, the new network element may comprise a new version of a network element that was previously deployed in the wireless communications network (e.g., an MME, an HSS, or the like). These network elements are typically put through a series of conformance test cases; however, these test cases tend to focus only on portions of the network element specification that are considered important and do not always perform a thorough verification.

In step 306, the processing system may acquire a plurality of specifications documents describing communication protocols between a plurality of network elements, including the new network element, and a plurality of user equipment of the wireless communications network. In one example, the plurality of specifications documents may include documents provided by standards bodies (e.g., 3^{rd} Generation Partnership Project, Internet Engineering Task Force, Global System for Mobile Communications Association, and/or the like) and/or documents provided by vendors of the plurality of network elements. Each of the specifications documents may be written in natural language and may comprise as many as thousands of pages of information about cellular (or other wireless) protocols, including information about expected events (e.g., messages, timeouts of timers, etc.) and corresponding actions from perspectives of the plurality of network elements and the plurality of user equipment.

In step 308, the processing system may translate, using a generative artificial intelligence technique, the plurality of specifications documents into a first finite state machine that models expected events and corresponding actions from perspectives of the plurality of network elements and the plurality of user equipment. In one example, the GenAI technique may take as input the plurality of specifications documents written in natural language and may generate as an output the first finite state machine. For instance, in one example, the GenAI technique may utilize an open-source NLP model to automatically identify the expected events and corresponding actions in the plurality of standards documents.

The GenAI technique may then connect the expected events and corresponding actions extracted from different parts of the plurality of specifications documents. Connecting the expected events and corresponding actions may include merging events or actions that are redundant to produce a single node in a connected graph (where the connected graph comprises the first finite state machine). In one example, the GenAI technique may utilize a GPT model.

It should be noted that in some cases, steps 306-308 may be performed before step 304. In other words, the specifications documents can be acquired and translated into the first finite state machine prior to an outage/deviant behavior being detected. In this case, the first finite state machine may be stored and retrieved from memory when an outage/deviant behavior is detected. This may reduce computational overhead relative to running the GenAI technique each time an outage/deviant behavior is detected.

In step 310, the processing system may translate, using the generative artificial intelligence technique, a plurality of event logs of the wireless communications network into a second finite state machine that models observed behaviors of the plurality of network elements and the plurality of user equipment.

In one example, prior to translating the plurality of event logs, the processing system may pre-process the event logs to facilitate construction of the second finite state machine. Pre-processing may involve extracting information from the event logs that dictates the behavior of the plurality of network elements and the plurality of user equipment. Automata learning algorithms may then be used to extract the second finite state machine from the pre-processed event logs.

The second finite state machine may thus represent how the plurality of network elements and the plurality of user equipment are actually interacting in the wireless communications network, as opposed to how the plurality of network elements and the plurality of user equipment are expected to be interacting based on the specifications documents.

In step 312, the processing system may detect, based on a comparison of the second finite state machine to the first finite state machine, that a behavior of the observed behaviors that that is associated with the new network element deviates from the communication protocols. In one example, if an observed behavior of the new network element deviates from expected behavior of the new network element (e.g., as defined by the communication protocols), then the second finite state machine may deviate from the first finite state machine. The deviation in the observed behavior of the new network element may be an indication that the new network element has been erroneously provisioned or is malfunctioning.

In one example, the comparison of the second finite state machine to the first finite state machine may involve converting events from the second finite state machine into natural language conditions/actions, mapping the natural language conditions/actions to corresponding nodes in the first finite state machine (e.g., using a GenAI technique), checking, after the mapping, if a path from one event to a next event exists (e.g., a path from one mapped node to the next mapped node in the first finite state machine), and detecting the behavior based on whether the path exists. In one example, if the path does not exist, then a deviation (e.g., unexpected behavior) is inferred. This is done because the network logs have higher abstractions than the specifications (e.g., a whole procedure containing multiple steps may be represented as a single event in a network log).

In step 314, the processing system may report an error associated with the new network element. As discussed above, a new network element that is observed to be behaving in an unexpected manner, based on the comparison of the first finite state machine to the second finite state machine, may be assumed to be malfunctioning or to be incorrectly provisioned. Thus, the new network element may require a software update or patch to correct the malfunction or erroneous provisioning.

In one example, reporting the error may involve reporting the error to a vendor of the new network element, so that the vendor can provide the appropriate software update or patch to correct the error. The method 300 may end in step 316.

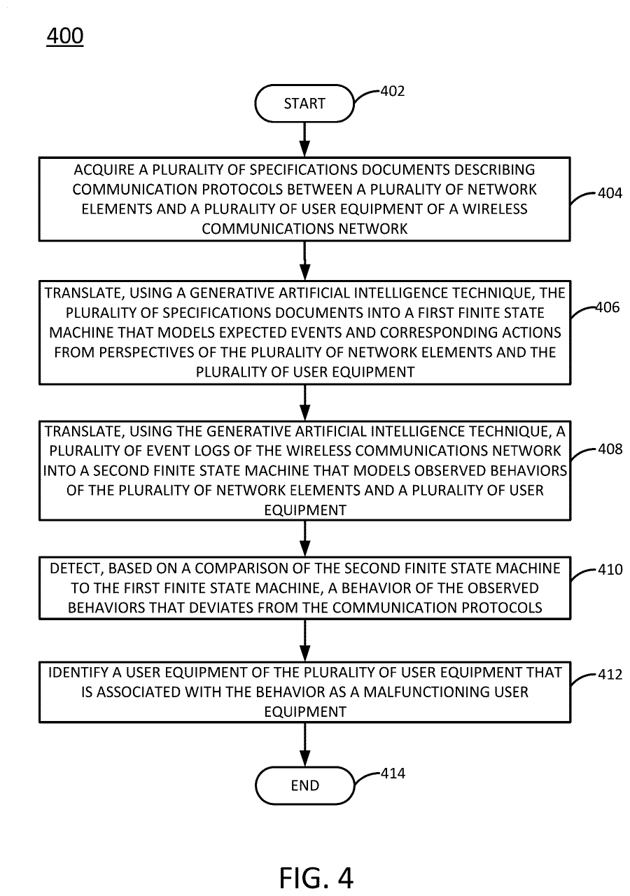

FIG. 4 illustrates a flowchart of an example method 400 for troubleshooting user equipment deployed in wireless communication networks using finite state machines, in accordance with the present disclosure. In one example, the method 400 may be performed by an application server that is capable of executing a GenAI technique, such as the AS 195 illustrated in FIG. 1. However, in other examples, the method 400 may be performed by another device, such as the processor 602 of the system 600 illustrated in FIG. 6. For the sake of example, the method 400 is described as being performed by a processing system.

The method 400 begins in step 402. In step 404, the processing system may acquire a plurality of specifications documents describing communication protocols between a plurality of network elements and a plurality of user equipment of a wireless communications network.

In one example, the plurality of specifications documents may include documents provided by standards bodies (e.g., 3^{rd} Generation Partnership Project, Internet Engineering Task Force, Global System for Mobile Communications Association, and/or the like) and/or documents provided by vendors of the plurality of network elements. Each of the specifications documents may be written in natural language and may comprise as many as thousands of pages of information about cellular (or other wireless) protocols, including information about expected events (e.g., messages, timeouts of timers, etc.) and corresponding actions from perspectives of the plurality of network elements and the plurality of user equipment.

In step 406, the processing system may translate, using a generative artificial intelligence technique, the plurality of specifications documents into a first finite state machine that models expected events and corresponding actions from perspectives of the plurality of network elements and the plurality of user equipment.

In one example, the GenAI technique may take as input the plurality of specifications documents written in natural language and may generate as an output the first finite state machine. For instance, in one example, the GenAI technique may utilize an open-source NLP model to automatically identify the expected events and corresponding actions in the plurality of standards documents.

The GenAI technique may then connect the expected events and corresponding actions extracted from different parts of the plurality of specifications documents. Connecting the expected events and corresponding actions may include merging events or actions that are redundant to produce a single node in a connected graph (where the connected graph comprises the first finite state machine). In one example, the GenAI technique may utilize a GPT model.

In step 408, the processing system may translate, using the generative artificial intelligence technique, a plurality of event logs of the wireless communications network into a second finite state machine that models observed behaviors of the plurality of network elements and the plurality of user equipment.

In one example, prior to translating the plurality of event logs, the processing system may pre-process the event logs to facilitate construction of the second finite state machine. Pre-processing may involve extracting information from the event logs that dictates the behavior of the plurality of network elements and the plurality of user equipment. Automata learning algorithms may then be used to extract the second finite state machine from the pre-processed event logs.

The second finite state machine may thus represent how the plurality of network elements and the plurality of user equipment are actually interacting in the wireless communications network, as opposed to how the plurality of network elements and the plurality of user equipment are expected to be interacting based on the specifications documents.

In step 410, the processing system may detect, based on a comparison of the second finite state machine to the first finite state machine, a behavior of the observed behaviors that deviates from the communication protocols. In one example, the comparison of the second finite state machine to the first finite state machine may involve converting events from the second finite state machine into natural language conditions/actions, mapping the natural language conditions/actions to corresponding nodes in the first finite state machine (e.g., using a GenAI technique), checking, after the mapping, if a path from one event to a next event exists (e.g., a path from one mapped node to the next mapped node in the first finite state machine), and detecting the behavior based on whether the path exists. In one example, if the path does not exist, then a deviation (e.g., unexpected behavior) is inferred. This is done because the network logs have higher abstractions than the specifications (e.g., a whole procedure containing multiple steps may be represented as a single event in a network log).

In one example, a deviation of the second finite state machine from the first finite state machine may indicate that at least one user equipment of the plurality of user equipment is behaving in a manner that is not expected. This unexpected behavior may comprise a malfunction of the user equipment.

For instance, the wireless communications network may support a large spectrum of user equipment from many different vendors and of many different models and capabilities. A malfunctioning user equipment may fail to receive reliable service from the wireless communications network. As an example, if a UE is rejected from the wireless communications network while attempting to establish a data connection, the UE should normally register again with the wireless communications network, from the beginning. If the UE does not register again, the UE may be malfunctioning (or at least behaving in a manner that is inconsistent with the specifications documents). An error of this nature, however, may not be readily apparent to a customer care agent of the wireless communications network operator.

In step 412, the processing system may identify a user equipment of the plurality of user equipment that is associated with the behavior as a malfunctioning user equipment. In one example, the processing system may identify the user equipment to a user of the user equipment, and may recommend that the user contact a vendor of the user equipment for a repair, a software update, or the like to correct the malfunction of the user equipment. The method 400 may end in step 414.

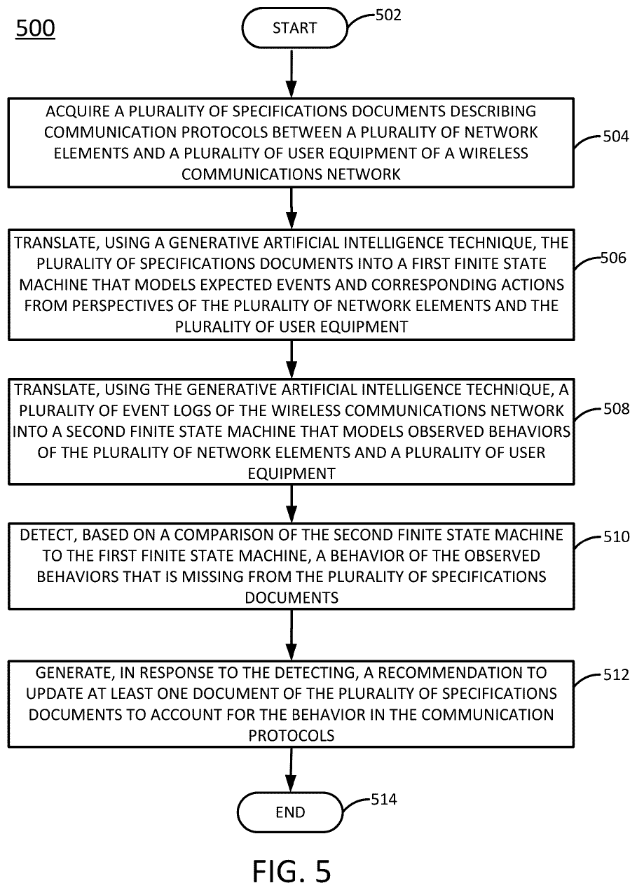

FIG. 5 illustrates a flowchart of an example method 500 for updating specifications documents for wireless communication networks using finite state machines, in accordance with the present disclosure. In one example, the method 500 may be performed by an application server that is capable of executing a GenAI technique, such as the AS 195 illustrated in FIG. 1. However, in other examples, the method 500 may be performed by another device, such as the processor 602 of the system 600 illustrated in FIG. 6. For the sake of example, the method 500 is described as being performed by a processing system.

The method 500 begins in step 502. In step 504, the processing system may acquire a plurality of specifications documents describing communication protocols between a plurality of network elements and a plurality of user equipment of a wireless communications network.

In one example, the plurality of specifications documents may include documents provided by standards bodies (e.g., 3^{rd} Generation Partnership Project, Internet Engineering Task Force, Global System for Mobile Communications Association, and/or the like) and/or documents provided by vendors of the plurality of network elements. Each of the specifications documents may be written in natural language and may comprise as many as thousands of pages of information about cellular (or other wireless) protocols, including information about expected events (e.g., messages, timeouts of timers, etc.) and corresponding actions from perspectives of the plurality of network elements and the plurality of user equipment.

In step 506, the processing system may translate, using a generative artificial intelligence technique, the plurality of specifications documents into a first finite state machine that models expected events and corresponding actions from perspectives of the plurality of network elements and the plurality of user equipment.

In one example, the GenAI technique may take as input the plurality of specifications documents written in natural language and may generate as an output the first finite state machine. For instance, in one example, the GenAI technique may utilize an open-source NLP model to automatically identify the expected events and corresponding actions in the plurality of standards documents.

The GenAI technique may then connect the expected events and corresponding actions extracted from different parts of the plurality of specifications documents. Connecting the expected events and corresponding actions may include merging events or actions that are redundant to produce a single node in a connected graph (where the connected graph comprises the first finite state machine). In one example, the GenAI technique may utilize a GPT model.

In step 508, the processing system may translate, using the generative artificial intelligence technique, a plurality of event logs of the wireless communications network into a second finite state machine that models observed behaviors of the plurality of network elements and the plurality of user equipment.

In one example, prior to translating the plurality of event logs, the processing system may pre-process the event logs to facilitate construction of the second finite state machine. Pre-processing may involve extracting information from the event logs that dictates the behavior of the plurality of network elements and the plurality of user equipment. Automata learning algorithms may then be used to extract the second finite state machine from the pre-processed event logs.

The second finite state machine may thus represent how the plurality of network elements and the plurality of user equipment are actually interacting in the wireless communications network, as opposed to how the plurality of network elements and the plurality of user equipment are expected to be interacting based on the specifications documents.

In step 510, the processing system may detect, based on a comparison of the second finite state machine to the first finite state machine, a behavior of the observed behaviors that is missing from the plurality of specifications documents.

In one example, the comparison of the second finite state machine to the first finite state machine may involve converting events from the second finite state machine into natural language conditions/actions, mapping the natural language conditions/actions to corresponding nodes in the first finite state machine (e.g., using a GenAI technique), checking, after the mapping, if a path from one event to a next event exists (e.g., a path from one mapped node to the next mapped node in the first finite state machine), and detecting the behavior based on whether the path exists. In one example, if the path does not exist, then a deviation (e.g., unexpected behavior) is inferred. This is done because the network logs have higher abstractions than the specifications (e.g., a whole procedure containing multiple steps may be represented as a single event in a network log).

In one example, a deviation of the second finite state machine from the first finite state machine may indicate that the specifications documents that were used to construct the first finite state machine may be incomplete or outdated. For instance, behaviors of a particular network element or UE in the specifications documents may be underspecified. As an example, TS 38.331 mandates that a network should only request UE information after security is established; however, TS 38.331 does not mention what the UE should do if the network requests UE information before security is established.

In step 512, the processing system may generate, in response to the detecting, a recommendation to update at least one document of the plurality of specifications documents to account for the behavior in the communication protocols. In one example, the recommendation may specify the content of an update to the specifications documents (e.g., update the specifications for TS 38.331 to specify what the UE should do if the network requests UE information before security is established). The recommendation may be delivered to an individual or organization that is responsible for maintaining the specifications documents (e.g., 3^{rd} Generation Partnership Project or the like). The method 500 may end in step 514.

Although not expressly specified above, one or more steps of the method 200, method 300, method 400, or method 500 may include a storing, displaying and/or outputting step as required for a particular application. In other words, any data, records, fields, and/or intermediate results discussed in the method can be stored, displayed and/or outputted to another device as required for a particular application. Furthermore, operations, steps, or blocks in FIG. 2, FIG. 3, FIG. 4, or FIG. 5 that recite a determining operation or involve a decision do not necessarily require that both branches of the determining operation be practiced. In other words, one of the branches of the determining operation can be deemed as an optional step. However, the use of the term “optional step” is intended to only reflect different variations of a particular illustrative embodiment and is not intended to indicate that steps not labelled as optional steps to be deemed to be essential steps. Furthermore, operations, steps or blocks of the above described method(s) can be combined, separated, and/or performed in a different order from that described above, without departing from the examples of the present disclosure. For instance, as discussed above, steps 206-208 of FIG. 2 may be performed before step 204, and steps 306-308 may be performed before step 304.

FIG. 6 depicts a high-level block diagram of a computing device specifically programmed to perform the functions described herein. For example, any one or more components or devices illustrated in FIG. 1 or described in connection with the method 200, method 300, method 400, or method 500 may be implemented as the system 600. For instance, an application server (such as might be used to perform the method 200, method 300, method 400, or method 500) could be implemented as illustrated in FIG. 6.

As depicted in FIG. 6, the system 600 comprises a hardware processor element 602, a memory 604, a module 605 for troubleshooting wireless communication networks using finite state machines, and various input/output (I/O) devices 306.

The hardware processor 602 may comprise, for example, a microprocessor, a central processing unit (CPU), or the like. The memory 604 may comprise, for example, random access memory (RAM), read only memory (ROM), a disk drive, an optical drive, a magnetic drive, and/or a Universal Serial Bus (USB) drive. The module 605 for troubleshooting wireless communication networks using finite state machines may include circuitry and/or logic for translating wireless specifications documents and/or wireless network event logs into finite state machines. The input/output devices 606 may include, for example, a camera, a video camera, storage devices (including but not limited to, a tape drive, a floppy drive, a hard disk drive or a compact disk drive), a receiver, a transmitter, a speaker, a display, a speech synthesizer, an output port, and a user input device (such as a keyboard, a keypad, a mouse, and the like), or a sensor.

Although only one processor element is shown, it should be noted that the computer may employ a plurality of processor elements. Furthermore, although only one computer is shown in the Figure, if the method(s) as discussed above is implemented in a distributed or parallel manner for a particular illustrative example, i.e., the steps of the above method(s) or the entire method(s) are implemented across multiple or parallel computers, then the computer of this Figure is intended to represent each of those multiple computers. Furthermore, one or more hardware processors can be utilized in supporting a virtualized or shared computing environment. The virtualized computing environment may support one or more virtual machines representing computers, servers, or other computing devices. In such virtualized virtual machines, hardware components such as hardware processors and computer-readable storage devices may be virtualized or logically represented.

It should be noted that the present disclosure can be implemented in software and/or in a combination of software and hardware, e.g., using application specific integrated circuits (ASIC), a programmable logic array (PLA), including a field-programmable gate array (FPGA), or a state machine deployed on a hardware device, a computer or any other hardware equivalents, e.g., computer readable instructions pertaining to the method(s) discussed above can be used to configure a hardware processor to perform the steps, functions and/or operations of the above disclosed method(s). In one example, instructions and data for the present module or process 605 for troubleshooting wireless communication networks using finite state machines (e.g., a software program comprising computer-executable instructions) can be loaded into memory 604 and executed by hardware processor element 602 to implement the steps, functions or operations as discussed above in connection with the example method 200, method 300, method 400, or method 500. Furthermore, when a hardware processor executes instructions to perform “operations,” this could include the hardware processor performing the operations directly and/or facilitating, directing, or cooperating with another hardware device or component (e.g., a co-processor and the like) to perform the operations.

The processor executing the computer readable or software instructions relating to the above described method(s) can be perceived as a programmed processor or a specialized processor. As such, the present module 605 for (including associated data structures) of the present disclosure can be stored on a tangible or physical (broadly non-transitory) computer-readable storage device or medium, e.g., volatile memory, non-volatile memory, ROM memory, RAM memory, magnetic or optical drive, device or diskette and the like. More specifically, the computer-readable storage device may comprise any physical devices that provide the ability to store information such as data and/or instructions to be accessed by a processor or a computing device such as a computer or an application server.

While various examples have been described above, it should be understood that they have been presented by way of example only, and not limitation. Thus, the breadth and scope of a preferred example should not be limited by any of the above-described examples, but should be defined only in accordance with the following claims and their equivalents.

What is claimed is:

1. A method comprising:
detecting, by a processing system including at least one processor, an outage in a wireless communications network;
acquiring, by the processing system, a plurality of specifications documents describing communication protocols between a plurality of network elements and a plurality of user equipment of the wireless communications network;
translating, by the processing system using a generative artificial intelligence technique, the plurality of specifications documents into a first finite state machine that models expected events and corresponding actions from perspectives of the plurality of network elements and the plurality of user equipment;
translating, by the processing system using the generative artificial intelligence technique, a plurality of event logs of the wireless communications network into a second finite state machine that models observed behaviors of the plurality of network elements and the plurality of user equipment;
detecting, by the processing system based on a comparison of the second finite state machine to the first finite state machine, a behavior of the observed behaviors that deviates from the communication protocols; and
identifying, by the processing system, a network element of the plurality of network elements that is associated with the behavior as a contributor to the outage 2. The method of claim 1, wherein the plurality of specifications documents includes documents provided by at least one of: a standards body, a vendor of at least one network element of the plurality of network elements, or a vendor of at least one user equipment of the plurality of user equipment.

3. The method of claim 2, wherein the standards body is at least one of: a third generation partnership project, an internet engineering task force, or a global system for mobile communications association.

4. The method of claim 1, wherein at least some specifications documents of the plurality of specifications documents are written in natural language.

5. The method of claim 4, wherein the generative artificial intelligence technique takes as an input the plurality of specifications documents written in natural language and generates as an output the first finite state machine.

6. The method of claim 5, wherein the generative artificial intelligence technique utilizes an open-source natural language processing model to automatically identify the expected events and corresponding actions in the plurality of standards documents.

7. The method of claim 6, wherein the generative artificial intelligence technique connects the expected events and corresponding actions extracted from different parts of the plurality of specifications documents in a connected graph.

8. The method of claim 7, wherein the generative artificial intelligence technique merges two or more events of the expected events or actions of the corresponding actions that are redundant to produce a single node in the connected graph.

9. The method of claim 1, wherein an automata learning algorithm is used to translate the plurality of event logs into the second finite state machine.

10. The method of claim 1, wherein the detecting indicates that at least one network element of the plurality of network elements is behaving in a manner that is not expected.

11. The method of claim 10, wherein the manner that is not expected comprises a malfunction of the at least one network element.

12. The method of claim 10, wherein the manner that is not expected comprises a use of the at least one network element that exceeds capabilities of the at least one network element.

13. The method of claim 1, wherein the identifying comprises identifying the network element in an alert to an administrator of the wireless communications network.

14. The method of claim 13, wherein the alert collects event logs corresponding to the network element for a further analysis by the administrator.

15. The method of claim 1, wherein another behavior of the observed behaviors that deviates from the communication protocols indicates that a new network element of the plurality of network elements was misconfigured.

16. The method of claim 1, wherein another behavior of the observed behaviors that deviates from the communication protocols indicates that a user equipment of the plurality of user equipment is malfunctioning.

17. The method of claim 1, wherein another behavior of the observed behaviors that deviates from the communication protocols indicates that the specifications documents are incomplete.

18. The method of claim 17, further comprising:
generating, by the processing system in response to the detecting, a recommendation to update at least one document of the plurality of specifications documents.

19. A non-transitory computer-readable medium storing instructions which, when executed by a processing system including at least one processor, cause the processing system to perform operations, the operations comprising:
detecting an outage in a wireless communications network;
acquiring a plurality of specifications documents describing communication protocols between a plurality of network elements and a plurality of user equipment of the wireless communications network;
translating, using a generative artificial intelligence technique, the plurality of specifications documents into a first finite state machine that models expected events and corresponding actions from perspectives of the plurality of network elements and the plurality of user equipment;
translating, using the generative artificial intelligence technique, a plurality of event logs of the wireless communications network into a second finite state machine that models observed behaviors of the plurality of network elements and the plurality of user equipment;
detecting, based on a comparison of the second finite state machine to the first finite state machine, a behavior of the observed behaviors that deviates from the communication protocols; and
identifying a network element of the plurality of network elements that is associated with the behavior as a contributor to the outage.

20. A device comprising:
a processing system including at least one processor; and
a computer-readable medium storing instructions which, when executed by the processing system, cause the processing system to perform operations, the operations comprising:
detecting an outage in a wireless communications network;
acquiring a plurality of specifications documents describing communication protocols between a plurality of network elements and a plurality of user equipment of the wireless communications network;
translating, using a generative artificial intelligence technique, the plurality of specifications documents into a first finite state machine that models expected events and corresponding actions from perspectives of the plurality of network elements and the plurality of user equipment;
translating, using the generative artificial intelligence technique, a plurality of event logs of the wireless communications network into a second finite state machine that models observed behaviors of the plurality of network elements and the plurality of user equipment;
detecting, based on a comparison of the second finite state machine to the first finite state machine, a behavior of the observed behaviors that deviates from the communication protocols; and
identifying a network element of the plurality of network elements that is associated with the behavior as a contributor to the outage.
